(19) United States
(12) Patent Application Publication
(10) Pub. No.: US 2024/0074430 A1
(43) Pub. Date: Mar. 7, 2024

(54) SELF-CONTAINED ELECTROMECHANICAL PEST REPELLING DEVICE

(71) Applicant: Kenneth Franklin Elliot, Lakeville, MA (US)

(72) Inventor: Kenneth Franklin Elliot, Lakeville, MA (US)

(21) Appl. No.: 18/232,870

(22) Filed: Aug. 11, 2023

Related U.S. Application Data
(60) Provisional application No. 63/403,095, filed on Sep. 1, 2022.

(51) Int. Cl. A01M 29/10; A01M 29/16

(52) U.S. Cl. CPC A01M 29/10; A01M 29/16; A01M 29/18

(57) ABSTRACT

A pest animal deterrent system including a support system including a mast attached to a tripod, the mast including an arm opposite the tripod; an optical module attached to the arm; a noise generator module attached to the arm, the noise generator module in operative communication with the optical module; a speaker in operative communication with the noise generator module; a battery electrically coupled to the optical module and the noise generator module; and a solar collector electrically coupled to the battery.

This application claims the benefit of provisional application Ser. No. 63/403,095, filed Sep. 1, 2022.

### BACKGROUND

The present disclosure is directed to the improved pest repelling device.

Pests, and/or pest animals, henceforth “pest animal(s)” can cause much damage to a crop before harvest. Damage can be inflicted by numerous methods such as but not limited to directly consuming the crop or seed, causing harm to the plants' skeletons or roots, or compromising the husk or fruits' protective properties. The results of a severe pest animal infestation can be devastating to a crops' ultimate yield.

There is a need to repel pest animals. Physical or visual deterrents such as but not limited to nets, reflective devices, spikes, repelling scents, and imitating devices are some examples of passive repelling devices. Active devices can utilize visual, auditory and/or other sensory means of deterrent. Examples of these devices include but are not limited to ultrasonic buzzers, sound cannons, light turrets, etc.

With the availability of compact inexpensive solar panels, active electrical and or electromechanical devices have become more popular for pest animal repelling in crop fields. When coupled with a solar power station utilizing a rechargeable battery these devices can be installed remotely in a crop field, programmed and left to operate autonomously.

Farms with multiple areas of crops may need to transport such devices within proper range to service the immediate pest animal targeted crop during the time period when the crop is vulnerable. Both active and passive devices have a limited range and time of efficacy. Typically, a single sensory deterrent device is installed to protect a crop. These devices can be effective on their own but through time pest animals may learn deterrent devices are no threat. Eventually they may and do move into the target crop despite the repelling device's presence. Once the stimulation is learned and deemed as no threat to the pest animal, the device may be deemed as ineffective by the user and its use discontinued. This further emphasizes the importance of mobile and/or active devices as the repelling features should only be utilized or displayed during the crop's time of need/vulnerability.

What is needed is a pest animal deterrent system which implements multiple means of sensory deterrents.

### SUMMARY

In accordance with the present disclosure, there is provided a pest animal deterrent system comprising a support system including a mast attached to a tripod, the mast including an arm opposite the tripod; an optical module attached to the arm; a noise generator module attached to the arm, the noise generator module in operative communication with the optical module; a speaker in operative communication with the noise generator module; a battery electrically coupled to the optical module and the noise generator module; and a solar collector electrically coupled to the battery.

A further embodiment of any of the foregoing embodiments may additionally and/or alternatively include the optical module is configured to generate a visual deterrent, simultaneously with the noise generator module configured to emit the auditory deterrent.

A further embodiment of any of the foregoing embodiments may additionally and/or alternatively include the optical module includes an illumination source configured to create the visual deterrence that moves relative to the ground.

A further embodiment of any of the foregoing embodiments may additionally and/or alternatively include the optical module includes a visible light laser diode combined with collimating optics configured to establish the visual deterrent, wherein the visual deterrent includes a movable output beam which creates a variable pattern.

A further embodiment of any of the foregoing embodiments may additionally and/or alternatively include the optical module includes a multi frequency laser system combined with associated optics.

A further embodiment of any of the foregoing embodiments may additionally and/or alternatively include the visual deterrent output beam is aimed below the horizon.

A further embodiment of any of the foregoing embodiments may additionally and/or alternatively include the noise generator module is configured to produce a sound saturation per area that includes a predetermined decibel level configured to agitate and scare a pest animal proximate a crop.

A further embodiment of any of the foregoing embodiments may additionally and/or alternatively include the noise generator module is configured to create animal distress calls.

A further embodiment of any of the foregoing embodiments may additionally and/or alternatively include the pest animal deterrent system is configured to produce dual stimulation, the dual stimulation including an audio deterrent stimulation and a visual deterrent stimulation of a target pest animal, the dual stimulation configured to create at least one of a perception that the auditory deterrent is a consequence of the visual deterrent and a perception that the visual deterrent is a consequence of the auditory deterrent.

A further embodiment of any of the foregoing embodiments may additionally and/or alternatively include the noise generator module is configured to create predator animal calls.

In accordance with the present disclosure, there is provided a pest animal deterrent system network comprising multiple systems including a first animal deterrent system in operative communication with a second animal deterrent system and an nth animal deterrent system; wherein the first animal deterrent system, the second animal deterrent system and the nth animal deterrent system cooperate to create simultaneous coordinated visual deterrent and auditory deterrent.

A further embodiment of any of the foregoing embodiments may additionally and/or alternatively include each of the first animal deterrent system, the second animal deterrent system and the nth animal deterrent system comprise a support system including a mast attached to a tripod, the mast including an arm opposite the tripod; an optical module attached to the arm; a noise generator module attached to the arm, the noise generator module in operative communication with the optical module; a main speaker in operative communication with the noise generator module; a battery electrically coupled to the optical module and the noise generator module; and a solar collector electrically coupled to the battery.

A further embodiment of any of the foregoing embodiments may additionally and/or alternatively include the pest animal deterrent system network further comprising additional speakers in operative communication with the noise generator module, the additional speakers configured to output the same deterring noises as the main speaker.

A further embodiment of any of the foregoing embodiments may additionally and/or alternatively include the additional speakers are configured to create a disorienting effect by being remotely located relative to each of the first animal deterrent system, second animal deterrent system and nth animal deterrent system; the additional speakers configured to output different deterring noises; and creating a disorienting effect.

A further embodiment of any of the foregoing embodiments may additionally and/or alternatively include each of the first animal deterrent system, the second animal deterrent system and the nth animal deterrent system utilizes the support system to suspend the noise generator module and the optical module components above a crop.

A further embodiment of any of the foregoing embodiments may additionally and/or alternatively include the optical module is configured to generate a visual deterrent, simultaneously with the noise generator module configured to emit the auditory deterrent; and the multiple systems networked in operative communication to provide an overlapping pattern with both visual deterrent and auditory deterrent.

In accordance with the present disclosure, there is provided a process for deterring a pest animal with a pest animal deterrent system comprising providing a support system including a mast attached to a tripod, the mast including an arm opposite the tripod; attaching an optical module to the arm; attaching a noise generator module to the arm; coupling the noise generator module in operative communication with the optical module; coupling a main speaker in operative communication with the noise generator module; electrically coupling a battery to the optical module and the noise generator module; and electrically coupling a solar collector to the battery.

A further embodiment of any of the foregoing embodiments may additionally and/or alternatively include the process further comprising generating a visual deterrent with the optical module; and simultaneously emitting an auditory deterrent with the noise generator module.

A further embodiment of any of the foregoing embodiments may additionally and/or alternatively include the process further comprising coupling additional speakers in operative communication with the noise generator module; configuring the additional speakers to create a disorienting effect by being remotely located relative to the main speaker; configuring the additional speakers to output different deterring noises; and creating a disorienting effect.

A further embodiment of any of the foregoing embodiments may additionally and/or alternatively include the process further comprising networking the pest animal deterrent system with at least one other pest animal deterrent system in operative communication to provide an overlapping pattern with both visual deterrent and auditory deterrent.

A further embodiment of any of the foregoing embodiments may additionally and/or alternatively include the process further comprising configuring the pest animal deterrent system to produce dual stimulation, the dual stimulation including an audio deterrent stimulation and a visual deterrent stimulation of a target pest animal; and configuring the dual stimulation to create at least one of a perception that the auditory deterrent is a consequence of the visual deterrent and a perception that the visual deterrent is a consequence of the auditory deterrent.

A further embodiment of any of the foregoing embodiments may additionally and/or alternatively include the process further comprising utilizing the support system to suspend the noise generator module and the optical module components above a crop.

A further embodiment of any of the foregoing embodiments may additionally and/or alternatively include the process further comprising configuring the noise generator module to produce a sound saturation per area that includes a predetermined decibel level configured to agitate and scare a pest animal proximate a crop.

Other details of the pest animal deterrent system are set forth in the following detailed description and the accompanying drawings wherein like reference numerals depict like elements.

### BRIEF DESCRIPTION OF THE DRAWINGS

FIG. 1 is a schematic representation of an exemplary pest animal deterrent system.

FIG. 2 is a schematic representation of the pest animal deterrent system of FIG. 1.

FIG. 3 is a schematic representation of the pest animal deterrent system of FIG. 1.

FIG. 4 is a schematic representation of multiple cooperating pest animal deterrent systems.

### DETAILED DESCRIPTION

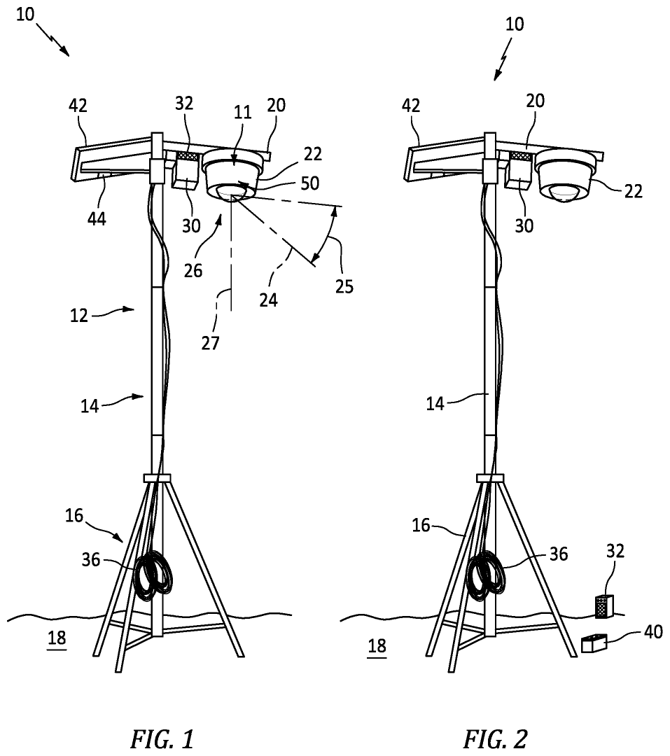

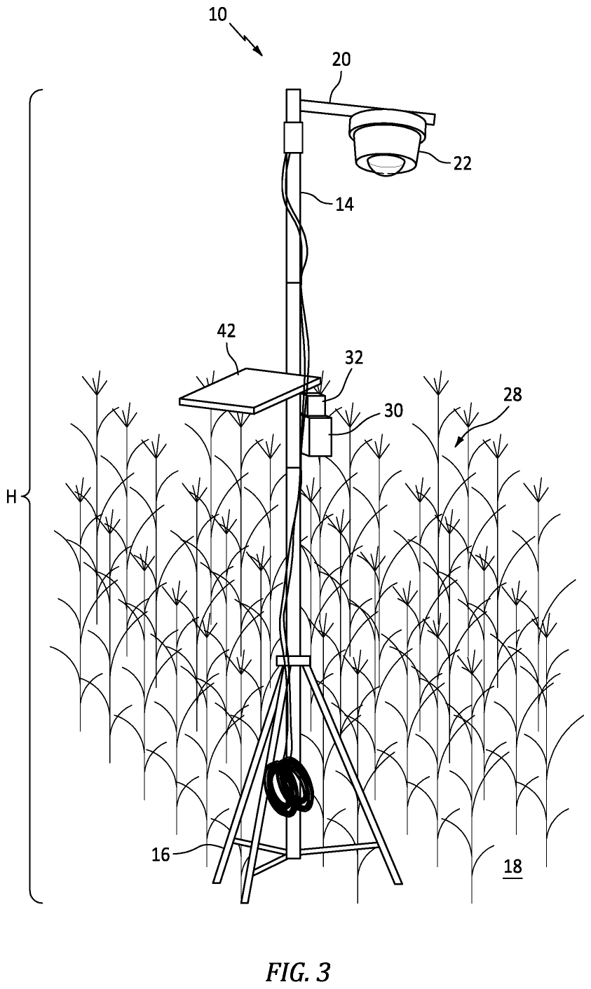

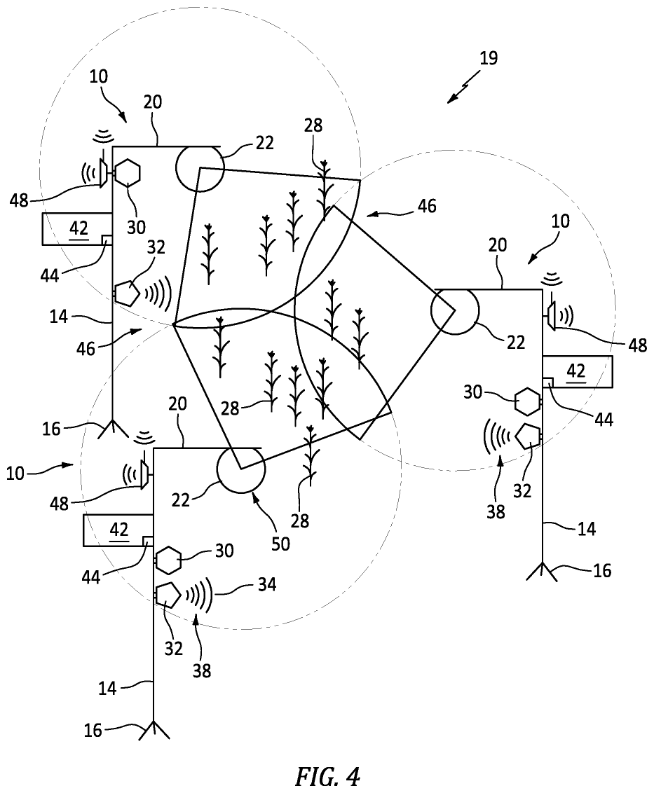

Referring now to FIG. 1, FIG. 2, FIG. 3 and FIG. 4, there is illustrated an exemplary pest animal deterrent system 10. The pest animal deterrent system 10 includes a support system 12. The support system 12 includes a mast 14 coupled to a tripod 16. The tripod 16 is configured to engage the ground 18 and stabilize the mast 14. The mast 14 can extend from the tripod 16 vertically relative to the ground 18. In another exemplary embodiment, mast 14 (without tripod 16) can be affixed to a suitable supporting structure within a crop field 19. The mast 14 can include an arm 20 that extends relatively horizontally from the mast 14. The mast 14 can extend from about 12 to about 15 feet from the ground 18 in an exemplary embodiment. In another exemplary embodiment, the mast 14 and tripod 16 can be portable, that is movable from one location to another location. The technical advantage of the portable mast 14 and tripod 16 allows for a single person to locate the pest animal deterrent system 10 to different locations on a farm with multiple crop fields 19 to maximize efficacy. Once the system is positioned in an optimum location it can be activated or deactivated during times of need. Since this system 10 is easily set up, moved or broken down for transport, it can be relocated so as not to interfere with farming processes such as cultivation, seeding, fertilization, and the like.

The pest animal deterrent system 10 includes an optical module 22. The optical module 22 mounts to the arm 20 of the support system 12. The optical module 22 is configured to generate a visual deterrent 24. The optical module 22 can include an illumination source 26. The illumination source 26 can be mobile, that is, capable of motion and creating the visual deterrent 24 that moves relative to the ground 18. The illumination source 26 can include a visible light (green) laser diode combined with collimating optics which is used to establish the visual deterrent 24.

In an exemplary embodiment, the visual deterrent output beam 24, in this case a laser beam, can be manipulated simultaneously through horizontal rotation and tilt or altitude to create spatial motion. The motion is enabled through the use of motors connected to a gear set and linkage which outputs a desired tilting angle 25 and 360 degrees of rotation about a vertical axis 27. Motion controllers or opto-mechanics such as a galvo mirror system can replace gear and linkage designs to precisely manipulate the output beam 24 simultaneously through rotation, tip and tilt. The output beam 24 can be seen by the pest animal and/or seen when illuminating a crop 28 providing visual deterrent. The moving beam 24 is projected down from a location above the crop 28. The illumination source 26 is contained within the optical module 22 in such a way that ensures the laser output beam 24 is never aimed above the horizon, preventing potentially illuminating undesired locations, objects, or hazards far away. The downward projected output beam 24 is not blocked by blowing or growing crops 28 and establishes a rotational scanning effect of a diameter determined from the designed tilt angle 25 and final device height H.

In an exemplary embodiment, the visual deterrent output beam 24 can include a variable pattern, that is random, for example a jagged circular raster pattern can be employed. In another example, a three-dimensional rotational raster pattern can be employed. The color of the visual deterrent output beam 24 can be any color that deters pest animals, including a green, a red, and multiple variable colors. The green light color is typically a bright color. The visual deterrent output beam 24 can include different/multiple laser light frequency(s), with synchronous or asynchronous motion with respect to one another.

The pest animal deterrent system 10 also includes a noise/audio generator module 30 in operative communication with at least one speaker 32. The noise generator module 30 can be used to establish an auditory deterrent 34 component of the system 10. The speaker 32 outputs the auditory deterrent, such as noise 34. The auditory deterrent 34 in conjunction to the moving visual deterrent 24 can be controlled by the system 10. The noise generator module 30 can employ piezoelectric elements and/or other electrical to audio transducers to emit sound. In addition to auditory sound frequencies, the noise generator module 30 can employ ultrasonic and subsonic frequencies.

In an exemplary embodiment, the speaker 32 can be attached to and interconnected to noise generator module 30 via the support mechanism 12 and interconnect cables 36. The speaker 32 can be positioned at some distance above the crop 28 to allow for unobstructed sound projection 38. Multiple speakers 32 can be strung together and placed at some distance away from the noise generator module 30. The additional speakers 32 can output the same deterring noises 34 as a main speaker 32. Additional speakers 32 could also be connected via wireless links. Additional speakers 32 can be used to create a disorienting effect, thus increasing the range or efficacy of the overall system. Remote speakers 32 can be used to output different deterring noises, thus increasing the disorienting effect and overall system efficiency.

The sound projection 38 can include a sound saturation per area that includes a volume and decibel level sufficient to be heard and to agitate and scare the pest animal proximate the crop 28. In an exemplary embodiment, the noise generator module 30 can create animal distress calls or other animal calls. The animal distress call can imitate the distress call of a particular animal that may be a pest animal or a predator of the pest animal. The noise generator module 30 can create a variety of distress/predator calls that are randomized on a loop. The noise generator module 30 can produce a first distress call of a first species and then a second distress call of a second species and then a predator call. In an exemplary embodiment, the distress call can imitate a black bird, a red wing starling, a Canadian starling, a grackle, an eagle call and the like.

The system 10 utilizes the tripod 16 and mast 14, as the support mechanism 12, to suspend the auditory and optical modules 30, 22 and ancillary components above the crop 28. The modules 30, 22 are connected to a replaceable and rechargeable battery 40 used to power the system 10 components. Attached to the mast 14 is a solar panel 42 and solar charge controller 44 keeping the battery 40 charged. Electrical power is provided by the rechargeable battery 40 and solar panel 42. The solar panel 42 can be positioned on the mast 14 a predetermined distance above the crop 28, so as not to be shaded. The rechargeable battery 40 can provide electrical power to the system 10 during periods of time when the solar panel 42 is not providing sufficient power. In an exemplary embodiment, alternative electrical energy can be stored in a capacitor or similar electrical storage devices. In an exemplary embodiment, alternative electrical generation supply can be employed, such as fuel cells.

A visible green laser beam 24 can be continuously rotated horizontally through 360 degrees around axis 27 while simultaneously tilting up and down through the angle 25. The output beam 24 can be seen by the pest animal and/or seen when illuminating the crop 28 resulting in visual deterrent 24. Additionally, a speaker 32 is used to output auditory noises 34 in conjunction to the moving laser light 24. One or more standalone pest deterrent systems can be placed throughout the crop field 19.

In an exemplary embodiment, as seen in FIG. 4, multiple systems 10 can be networked in operative communication to provide an overlapping pattern 46 with both visual deterrent 24 and auditory deterrent 34 discharges. Each of the systems 10 can communicate and coordinate to detect and to respond to the presence of the pest animal. A transceiver communication unit 48 can be employed for each system 10 to enable the operative communication which is supervised by master controller 50.

Optical module 22 provides an environmentally resistant enclosure for the mechanism providing illumination source 26 motion and a window allowing visual deterrent beam 24 transmission. Additionally, optical module 22 can contain ancillary devices that control and operate deterrent system 10, including electric eye 11, master controller 50 and connectors for interconnect cables. The system 10 uses a combination of available off the shelf components as listed above such as motors, gearboxes, laser diode, collimating optics, etc., as well as manufactured aluminum and polymer structures. The solar panel 42 and battery 40 need to be sized to provide adequate power given constraints including climatological conditions and current draw. Modules 22, 30 are affixed to the tripod 16 and mast 14, similar to roof mounted TV antenna mounting hardware as illustrated in the figures. Interconnections are electrical cables. Locate the system 10 in an optimum location. Activate during times of need when pest animals must be repelled. Deactivate when not needed. Since the system is portable, it can be moved by an individual as required.

The system 10 enables dual, audio and visual stimulation of the target pest animal which may perceive the auditory deterrent 34 component to be a consequence of the visual deterrent 24 component or vice versa. This can overwhelm the pest animal creating a lasting efficacy as has been demonstrated in field trials.

The following summarize a multiyear field test during high bird pressure periods: year 1 and earlier seasons without this system a 70% to 80% crop loss was suffered; years 2 through 4 implementing this system a, 1% crop loss was suffered; years 5 through 8 (present) implementing this system, a 5% crop loss was suffered.

A technical advantage of the disclosed pest animal deterrent system includes the system and housing, controls and supplies power to all sensory deterrents.

Another technical advantage of the disclosed pest animal deterrent system includes the system is self-contained and self-charging.

Another technical advantage of the disclosed pest animal deterrent system includes the system can be conveniently moved to protect the current plot or crop in need.

Another technical advantage of the disclosed pest animal deterrent system includes the system is simple to set up and requires no additional devices to operate.

Another technical advantage of the disclosed pest animal deterrent system includes the system needs no programming or external input and can operate autonomously.

There has been provided a pest animal deterrent system. While the pest animal deterrent system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A pest animal deterrent system comprising:
a support system including a mast attached to a tripod, the mast including an arm opposite the tripod;
an optical module attached to the arm;
a noise generator module attached to the arm, the noise generator module in operative communication with the optical module;
a speaker in operative communication with the noise generator module;
a battery electrically coupled to the optical module and the noise generator module; and
a solar collector electrically coupled to the battery.

2. The pest animal deterrent system according to claim 1, wherein the optical module is configured to generate a visual deterrent, simultaneously with the noise generator module configured to emit the auditory deterrent.

3. The pest animal deterrent system according to claim 2, wherein the optical module includes an illumination source and mechanics configured to create the visual deterrence that moves relative to the ground.

4. The pest animal deterrent system according to claim 2, wherein the optical module includes a visible light laser diode combined with collimating optics and mechanics configured to establish the visual deterrent, wherein the visual deterrent includes a moving output beam which creates a variable pattern.

5. The pest animal deterrent system according to claim 4 wherein the optical module includes a multi frequency laser system combined with associated optics.

6. The pest animal deterrent system according to claim 4, wherein the visual deterrent output beam is aimed below the horizon.

7. The pest animal deterrent system according to claim 1, wherein the noise generator module is configured to produce a sound saturation per area that includes a predetermined decibel level configured to agitate and scare a pest animal proximate a crop.

8. The pest animal deterrent system according to claim 1, wherein the noise generator module is configured to create animal distress calls.

9. The pest animal deterrent system according to claim 1, wherein the pest animal deterrent system is configured to produce dual stimulation, the dual stimulation including an audio deterrent stimulation and a visual deterrent stimulation of a target pest animal, the dual stimulation configured to create at least one of a perception that the auditory deterrent is a consequence of the visual deterrent and a perception that the visual deterrent is a consequence of the auditory deterrent.

10. The pest animal deterrent system according to claim 1, wherein the noise generator module is configured to create predator animal calls.

11. A pest animal deterrent system network comprising:
multiple systems including a first animal deterrent system in operative communication with a second animal deterrent system and an nth animal deterrent system; wherein the first animal deterrent system, the second animal deterrent system and the nth animal deterrent system cooperate to create simultaneous coordinated visual deterrent and auditory deterrent.

12. The pest animal deterrent system network according to claim 11, wherein each of the first animal deterrent system, the second animal deterrent system and the nth animal deterrent system comprise:
a support system including a mast attached to a tripod, the mast including an arm opposite the tripod;
an optical module attached to the arm;
a noise generator module attached to the arm, the noise generator module in operative communication with the optical module;
a main speaker in operative communication with the noise generator module;
a battery electrically coupled to the optical module and the noise generator module; and
a solar collector electrically coupled to the battery.

13. The pest animal deterrent system network according to claim 12, further comprising:
additional speakers in operative communication with the noise generator module, the additional speakers configured to output the same deterring noises as the main speaker.

14. The pest animal deterrent system network according to claim 13, wherein the additional speakers are configured to create a disorienting effect by being remotely located relative to each of the first animal deterrent system, second animal deterrent system and nth animal deterrent system; the additional speakers configured to output different deterring noises; and creating a disorienting effect.

15. The pest animal deterrent system network according to claim 11, wherein each of the first animal deterrent system, the second animal deterrent system and the nth animal deterrent system utilizes the support system to suspend the noise generator module and the optical module components above a crop.

16. The pest animal deterrent system network according to claim 11, wherein the optical module is configured to generate a visual deterrent, simultaneously with the noise generator module configured to emit the auditory deterrent; and
the multiple systems networked in operative communication to provide an overlapping pattern with both visual deterrent and auditory deterrent.

17. A process for deterring a pest animal with a pest animal deterrent system comprising:
providing a support system including a mast attached to a tripod, the mast including an arm opposite the tripod;
attaching an optical module to the arm;
attaching a noise generator module to the arm;
coupling the noise generator module in operative communication with the optical module;
coupling a main speaker in operative communication with the noise generator module;
electrically coupling a battery to the optical module and the noise generator module; and
electrically coupling a solar collector to the battery.

18. The process of claim 17, further comprising:
generating a visual deterrent with the optical module;
and simultaneously emitting an auditory deterrent with the noise generator module.

19. The process of claim 17, further comprising:
coupling additional speakers in operative communication with the noise generator module;
configuring the additional speakers to create a disorienting effect by being remotely located relative to the main speaker;
configuring the additional speakers to output different deterring noises; and
creating a disorienting effect.

20. The process of claim 17, further comprising:
networking the pest animal deterrent system with at least one other pest animal deterrent system in operative communication to provide an overlapping pattern with both visual deterrent and auditory deterrent.

21. The process of claim 17, further comprising:
configuring the pest animal deterrent system to produce dual stimulation, the dual stimulation including an audio deterrent stimulation and a visual deterrent stimulation of a target pest animal; and
configuring the dual stimulation to create at least one of a perception that the auditory deterrent is a consequence of the visual deterrent and a perception that the visual deterrent is a consequence of the auditory deterrent.

22. The process of claim 17, further comprising:
utilizing the support system to suspend the noise generator module and the optical module components above a crop.

23. The process of claim 22, further comprising:
configuring the noise generator module to produce a sound saturation per area that includes a predetermined decibel level configured to agitate and scare a pest animal proximate a crop.
